(19) United States
(12) Patent Application Publication
(10) Pub. No.: US 2023/0028314 A1
(43) Pub. Date: Jan. 26, 2023

(54) BEND RADIUS INSENSITIVE IMPEDANCE IN HIGH-SPEED CABLE

(71) Applicant: DELL PRODUCTS, LP, Round Rock, TX (US)

(72) Inventors: Sandor Farkas, Round Rock, TX (US); Bhyrav Mutnury, Austin, TX (US)

(21) Appl. No.: 17/382,228

(22) Filed: Jul. 21, 2021

(51) Int. Cl. H01B 11/18

(52) U.S. Cl. CPC H01B 11/1808; H01B 11/1843; H01B 3/28

(57) ABSTRACT

A twin-axial cable is provided for high-speed data communication. The twin-axial cable includes a first conductor surrounded by a first portion of an incompressible insulating material and a second conductor surrounded by a second portion of the incompressible insulating material. The first and second conductors are arranged in line in a first axis at a distance apart. A profile of the first and second portions is an elongated profile along a second axis perpendicular to the first axis, such that a first height of the profile is greater than the distance.

### FIELD OF THE DISCLOSURE

This disclosure generally relates to information handling systems, and more particularly relates to providing bend radius insensitive impedance in a high-speed data cable for an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A twin-axial cable may be provided for high-speed data communication. The twin-axial cable may include a first conductor surrounded by a first portion of an incompressible insulating material and a second conductor surrounded by a second portion of the incompressible insulating material. The first and second conductors may be arranged in line in a first axis at a distance apart. A profile of the first and second portions may be an elongated profile along a second axis perpendicular to the first axis, such that a first height of the profile is greater than the distance.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates twin-axial cable according to the prior art;

FIG. 2 illustrates the impedance of the twin-axial cable of FIG. 1;

FIG. 3 illustrates twin-axial cable according to an embodiment of the current disclosure;

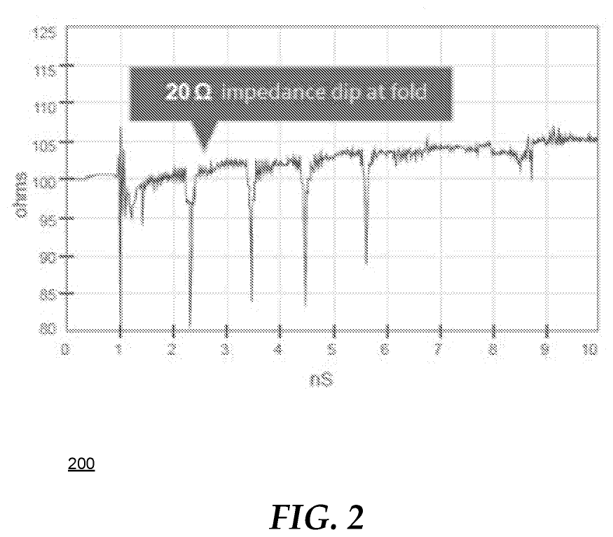

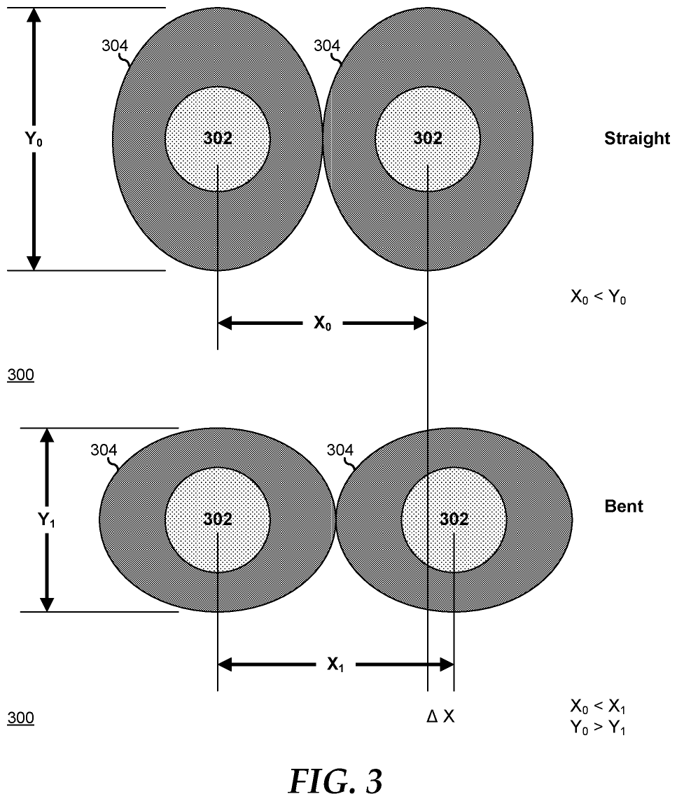

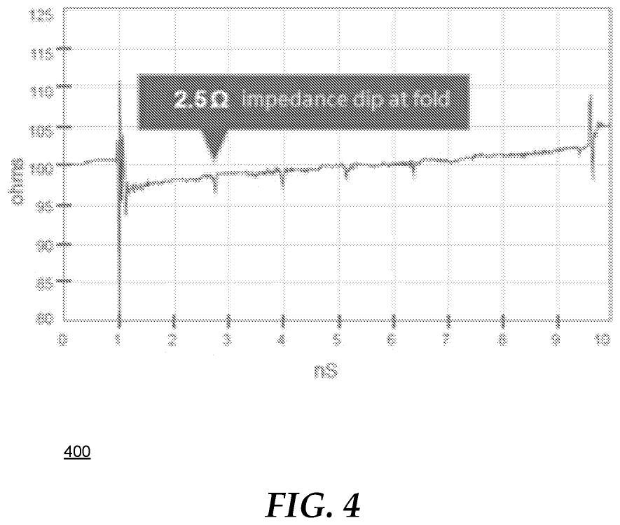

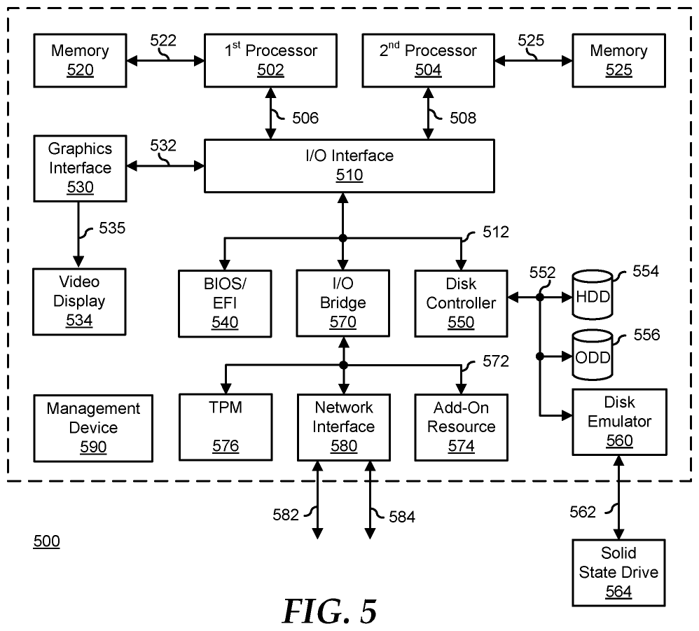

FIG. 2 illustrates the impedance of the twin-axial cable of FIG. 3;

FIG. 5 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

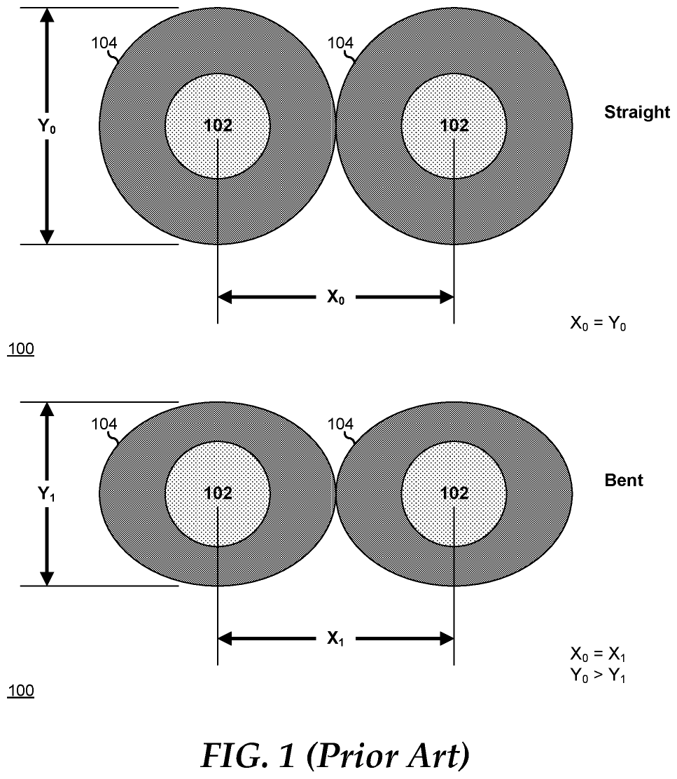

FIG. 1 illustrates a twin-axial (twinax) cable 100 according to the prior art, including two signal conductors 102, each surrounded by an insulating material 104. Twinax cable 100 is similar to a coaxial cable, except that there are two conductors instead of the one conductor found in the coaxial cable, and may be utilized in the transmission of various high-speed data communication interfaces, and particularly where such high-speed data communication interfaces utilize double-ended differential signaling. Exemplary uses of twinax cable 100 may include cabling associated with Small Form Factor Pluggable (SFP+) enabled devices for 10 Gigabit Ethernet applications, with 40GBASE-CR4 or 100GBASE-CR10 Ethernet applications, with SATA 3.0 applications, DisplayPort applications, PCIe applications, proprietary high-speed data communication applications, or the like.

Signal conductors 102 may be provided in various materials including copper, aluminum, silver plated copper, copper plated steel, or other materials as needed or desired, and may be solid conductors, braided conductors, or the like. Insulating material 104 may be provided in various materials including compressible materials such as a polyethylene foam or other materials as needed or desired. Twinax cable 100 may further include a conductive shield (not illustrated) material (not illustrated) around insulating material 104 to improve noise immunity in the surrounded signal conductors 102, as needed or desired. Such a conductive shield material may include a braided copper shield, a foil shield, or the like. Twinax cable 100 may further include one or more drain conductor, as needed or desired. Finally, twinax cable 100 may include an insulating jacket (not illustrated), as needed or desired. The details of twinax cable construction are known in the art and will not be further described herein, except as needed to illustrate the current embodiments.

Twinax cable 100 is formed with each insulating material 104 in a circular shape around respective signal conductors 102. As such each insulating material 104 will have a width shown as X₀, as illustrated by a center-to-center dimension, with a height of Y₀, and where the width and height are substantially equal, that is, where (X₀=Y₀), with some minor variation due to the possible attaching of the insulating materials together in the fabrication process, as needed or desired. When twinax cable 100 is bent, the bend results in a compression of the height of the insulating material.

FIG. 1 illustrates two cross sections of twinax cable 100. The top image shows twinax cable 100 in a straight section, and the bottom image shows the twinax cable in a section where the twinax cable is bent, such as around an element of equipment in an information handling system. In the straight portion, the distance between signal conductors 102 is shown (X₀) and the height of insulating material 104 is shown (Y₀). In the bent portion, the distance between signal conductors 102 is shown (X₁) and the height of insulating material 104 is shown (Y₁). Here, it can be seen that the distance between signal conductors 102 remains constant, that is, that (X₀=X₁), whether twinax cable 100 is straight or is bent. However, because insulating material 104 is compressible, it can be further seen that the height of insulating material 104 changes in the bent portion, becoming thinner than in the straight portion, such that (Y₀>Y₁).

It has been understood that when a twinax cable similar to twinax cable 100 is bent, such as around an element of equipment in an information handling system, that the impedance of the twinax cable may be seen to drop due to the thinning of insulating material 104. Such an impedance drop in the region of a bend in a twinax cable may be in the range of 5-20 ohms, which is a sufficient impedance change that high-speed data signals may experience excessive loss and unwanted reflections on the twinax cable, making for poor signal integrity in the circuit that employs the twinax cable. FIG. 2 illustrates an impedance profile of a twinax cable with bend at various locations in the cable. Note that the impedance drop may be as much as 20 ohms.

FIG. 3 illustrates a twin-axial (twinax) cable 300 according to an embodiment of the current disclosure, including two signal conductors 302, each surrounded by an insulating material 304. Twinax cable 300 is similar to a twinax cable 100. Twinax cable 300 may further include a conductive shield material (not illustrated) around insulating material 304 to improve noise immunity in the surrounded signal conductors 302, as needed or desired. Twinax cable 300 may further include one or more drain conductor (not illustrated), as needed or desired. Finally, twinax cable 300 may include an insulating jacket (not illustrated), as needed or desired.

Twinax cable 300 is formed with each insulating material 304 with an elongated height with respect to the width around respective signal conductors 302. As such each insulating material 304 will have a width shown as X₀, as illustrated by a center-to-center dimension, with a height of Y₀, and where (X₀<Y₀). For example, insulating material 304 may have a profile that is elliptical, oblong, oval, or another elongated shape, with some minor variation due to the possible attaching of the insulating materials together in the fabrication process, as needed or desired. Moreover, insulating material 304 is formed of an incompressible material that maintains its volume when deformed. An example of an incompressible material may include silicon rubber, natural rubber, or another incompressible material that has suitable insulating properties, as needed or desired. When twinax cable 300 is bent, the bend results in a defomation that decreases of the height of insulating material 304, but simultaneously increases the width of the insulating material.

FIG. 3 illustrates two cross sections of twinax cable 300. The top image shows twinax cable 300 in a straight section, and the bottom image shows the twinax cable in a section where the twinax cable is bent, such as around an element of equipment in an information handling system. In the straight portion, the distance between signal conductors 302 is shown (X₀) and the height of insulating material 304 is shown (Y₀). In the bent portion, the distance between signal conductors 302 is shown (X₁) and the height of insulating material 304 is shown (Y₁). Here, it can be seen that the distance between signal conductors 302 increases, that is, that (X₀<X₁), when twinax cable 300 is bent, because insulating material 304 is incompressible, and because the height of the insulating material decreases when the twinax cable is bent, such that (Y₀>Y₁). As noted above, the decrease in the height of insulating material 304 under bending results in a drop in the impedance of twinax cable 300. However, the accompanying increase in the width of insulating material 304, and the consequent increasing of the distance between signal conductors 302, results in an offsetting increase in the impedance of twinax cable 300. FIG. 4 illustrates an impedance profile of a twinax cable with bend at various locations in the cable. Note that the impedance drop may be as little as 2.5 ohms.

The impedance of a twinax cable similar to twinax cable 300 may be given as:

Z=f(X,Y) Equation 1

where Z is the impedance. It has been understood that, to ensure that the impedance remains constant with bending, that is, where:

Z₀=f(X₀,Y₀)=f(X₁,Y₁) Equation 2,

then:

Increase in X=2*Decrease in Y Equation 3,

or:

ΔX=−2*ΔY Equation 4,

or, equivalently:

dX/dY=−2 Equation 5.

Where the profile of the insulating material is eliptical, then the cross sectional area of the insulating material is given as:

A=H/2*W/2*π=π/2(H*W) Equation 6,

where A is the cross sectional area, H is the height (Y₀ or Y₁) and W is the width (X₀ or X₁). Then, by substitution:

A∝(Y₀+ΔY)*(X₀+ΔX)=(Y₀*X₀)+(Y₀*ΔX)+(ΔY*X₀)+(ΔY*ΔX) Equation 7.

However, because the insulating material is incompressible, then:

(Y₀*ΔX)+(ΔY*X₀)=0 Equation 8,

or:

(Y₀*ΔX)=−(ΔY*X₀) Equation 9.

Thus, substituting equation 5, for providing constant impedance, then an elliptical twinax cable will have a constant impedance when:

H=2*W Equation 10.

FIG. 4 illustrates an impedance profile of a twinax cable with an elliptical profile that satisfies equation 10 where the twinax cable has bends at various locations in the cable. Note that the impedance drop may be as little as 2.5 ohms or less.

FIG. 5 illustrates a generalized embodiment of an information handling system 500. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below, and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, and a management device 590. Processors 502 and 504, I/O interface 510, memory 520, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532, and provides a video display output 535 to a video display 534. In a particular embodiment, information handling system 500 includes separate memories that are dedicated to each of processors 502 and 504 via separate memory interfaces. An example of memories 520 and 525 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 1394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512, or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500. Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. A twin-axial cable for high-speed data communication, the twin-axial cable comprising:
a first conductor surrounded by a first portion of an incompressible insulating material, the first conductor having a circular profile; and
a second conductor surrounded by a second portion of the incompressible insulating material, the second conductor having a circular profile, wherein the first and second conductors are arranged in line in a first axis at a distance apart;
wherein a profile of the first and second portions is an elongated profile along a second axis perpendicular to the first axis, such that a first height of the profile is greater than the distance.

2. The twin-axial cable of claim 1, wherein in bending the twin-axial cable, the height of the profile decreases from the first height to a second height.

3. The twin-axial cable of claim 2, wherein in bending the twin-axial cable, the distance increases from a first distance to a second distance.

4. The twin-axial cable of claim 1, wherein, in bending the twin-axial cable, an impedance of twin-axial cable remains within five ohms of a nominal impedance of the twin-axial cable when not bent.

5. The twin-axial cable of claim 1, wherein the elongated profile is an oblong profile.

6. The twin-axial cable of claim 1, wherein the elongated profile is an elliptical profile.

7. The twin-axial cable of claim 1, wherein the height of the profile is two times the distance between the first and second conductors.

8. The twin-axial cable of claim 1, wherein the incompressible insulating material includes a silicone rubber material.

9. The twin-axial cable of claim 1, wherein the first and second conductors are copper conductors.

10. A method of forming a twin-axial cable for high-speed data communication, the method comprising:
surrounding a first conductor with a first portion of an incompressible insulating material, the first conductor having a circular profile; and
surrounding a second conductor with a second portion of the incompressible insulating material, the second conductor having the circular profile, wherein the first and second conductors are arranged in line in a first axis at a distance apart;
wherein a profile of the first and second portions is an elongated profile along a second axis perpendicular to the first axis, such that a first height of the profile is greater than the distance.

11. The method of claim 10, wherein in bending the twin-axial cable, the height of the profile decreases from the first height to a second height.

12. The method of claim 11, wherein in bending the twin-axial cable, the distance increases from a first distance to a second distance.

13. The method of claim 10, wherein, in bending the twin-axial cable, an impedance of twin-axial cable remains within five ohms of a nominal impedance of the twin-axial cable when not bent.

14. The method of claim 10, wherein the elongated profile is an oblong profile.

15. The method of claim 10, wherein the elongated profile is an elliptical profile.

16. The method of claim 10, wherein the height of the profile is two times the distance between the first and second conductors.

17. The method of claim 10, wherein the incompressible insulating material includes a silicone rubber material.

18. The method of claim 10, wherein the first and second conductors are copper conductors.

19. A twin-axial cable for high-speed data communication, the twin-axial cable comprising:
a first conductor surrounded by a first portion of an incompressible insulating material, the first conductor having a circular profile; and
a second conductor surrounded by a second portion of the incompressible insulating material, the second conductor having the circular profile, wherein the first and second conductors are arranged in line in a first axis at a distance apart;
wherein a profile of the first and second portions is an elongated profile along a second axis perpendicular to the first axis, such that a first height of the profile is greater than the distance, wherein the profile is an elliptical profile, and wherein the height of the profile is two times the distance between the first and second conductors.

20. The twin-axial cable of claim 1, wherein in bending the twin-axial cable, the height of the profile decreases from the first height to a second height, and the distance increases from a first distance to a second distance.
